(19) United States
(12) Patent Application Publication
(10) Pub. No.: US 2016/0057080 A1
(43) Pub. Date: Feb. 25, 2016

(54) MESSAGE TRANSMISSION AND RECEPTION DEVICE, AUTOMATIC METER READING SYSTEM, AND MESSAGE TRANSMISSION AND RECEPTION METHOD

(71) Applicant: MITSUBISHI ELECTRIC CORPORATION, Chiyoda-ku, Tokyo (JP)

(72) Inventor: Toru MUSO, Chiyoda-ku (JP)

(73) Assignee: MITSUBISHI ELECTRIC CORPORATION, Chiyoda-ku, Tokyo (JP)

(21) Appl. No.: 14/783,027

(22) PCT Filed: Jul. 16, 2013
(86) PCT No.: PCT/JP2013/004326

§ 371 Date: Oct. 7, 2015

(51) Int. Cl. H04L 12/933; H04B 7/15

(52) U.S. Cl. CPC H04L 49/15; H04B 7/15

(57) ABSTRACT

A message transmission/reception device preferentially processing high priority messages even in a multi-vendor environment where presence/absence of priority control function depends on each vendor. The message transmission/reception device receives, through a relay, an upstream direction message transmitted from a communication terminal to an application server, and transmits, through the relay to the communication terminal, a downstream message transmitted from the application server to the communication terminal. When receiving a high priority message, the number of messages passed by the high priority message during a period from transmitting the high priority message from the relay to receiving the high priority message is calculated. A threshold determining the amount of messages to be transmitted to the relay device is adjusted based on the calculated message number. The amount of messages to be transmitted is controlled based on comparing the number of downstream messages accumulated in the relay and the threshold.

### TECHNICAL FIELD

The present invention relates to a message transmission and reception device and a message priority control method for transmitting and receiving, by message communication, data such as meter readings of a smart meter and control data of an application server.

### BACKGROUND ART

In our country and foreign countries, automatic meter reading systems for electricity, gas, water supply, or the like are being introduced in which smart meters are used. A smart-meter automatic reading system has a tree-structured network with which smart meters, relay devices, message transmission and reception devices, and application servers are connected; and the system includes several millions or more of smart meters, several to tens of thousands of relay devices, several to a dozen or so of message transmission and reception devices, and several to tens of application servers. The smart meters and the relay devices have a low calculation capability and thereby have limitation for processing.

In a smart-meter automatic reading system, the bandwidths, communication speeds, communication media, and communication methods are different among a network between the smart meters and the relay device, a network between the relay devices and the message transmission and reception devices, and a network between the message transmission and reception devices and the application servers. In such non-homogeneous networks, the application servers and the smart meters transmit and receive data such as meter readings, and control information such as switching control, using message communication.

The transmitted or received messages include upstream messages (from the meters or the relay device to the application) and downstream messages (from the application to the relay devices or the meters), and there coexist messages spontaneously transmitted by the meters or relay devices, unidirectional messages with which the applications unilaterally command and control, and bidirectional messages with which the meters or relay devices reply in response to the commands from the applications. The communication amounts of the upstream messages and downstream messages are asymmetrical, and become large in certain time slots and become small in other time slots, exhibiting a characteristic of non-constant communication amounts.

Furthermore, there exist many-to-one communication such as regular meter reading by which to communicate over several million messages within a predetermined time, one-to-one communication by which to obtain information of a certain meter, and one-to-many communication by which to, for example, update firmware of the meters or relay devices. Furthermore, the characteristics of the applications are various, and there coexist a throughput requiring application, a response performance requiring application, and an application having a constraint to be completed within a specific time.

As described above, in the smart-meter automatic reading system, it is necessary to effectively perform priority control of messages according to applications having various kinds of characteristics, in the non-homogeneous and asymmetrical networks with which devices having great limitation are connected. Furthermore, in the smart-meter automatic reading system, smart meters and relay devices from a plurality of vendors are connected, in which implemented priority control methods may differ depending on the vendors, and some of which may have no priority control function. In a case where a relay device having no priority control function is connected, when low priority messages accumulate in a buffer of the relay device, a high priority message later transmitted is made to wait until the accumulated messages are processed.

In such a case, in order to obtain an effect of the priority control, it is necessary to control the amount of message transmission so as to reduce the amount of accumulated messages, so that the waiting time of the high priority message is reduced. In a conventional technique, the transmission amount is controlled by monitoring the accumulated message amount and stopping, when the accumulated message amount exceeds a certain threshold, transmitting messages from the transmission side for a certain period (for example, Patent Document 1). By using this technique, an effect of reducing the waiting time of the high priority message can be obtained even when the relay device having no priority control function is connected.

### PRIOR ART DOCUMENT

### Patent Document

Patent Document 1: Japanese Patent Laid-Open Publication No. 2004-56328

### SUMMARY OF THE INVENTION

### Problem to be Solved by the Invention

In a case where the conventional technique is used, the amount of accumulated messages are monitored, and the transmission amount from a transmission side is controlled when the accumulated message amount exceeds a predetermined threshold; therefore, a high priority message can be preferentially processed even for the relay device having no priority control function. However, in a multi-vendor environment such as a smart-meter automatic reading system in which smart meters and relay devices from a plurality of vendors are connected, there has been a problem that it is difficult to implement a similar control function for the relay device products from other companies. Furthermore, there has been a problem that it is difficult to set a suitable threshold to limit the accumulated message amount depending on whether or not the priority control function is implemented in other companies' relay devices, or depending on the implemented priority control methods.

The present invention is made to solve the problems described above, and aims to provide a message transmission and reception device that can preferentially process a high priority message even in a multi-vendor environment in which the presence or absence of the priority control function and the implemented priority control methods are different depending on each vendor.

### Means for Solving Problem

The present invention relates to a message transmission and reception device that receives, through a relay device, an upstream message transmitted from a wireless terminal to an application server, and that transmits, through the relay device to the wireless terminal, a downstream message transmitted from the application server to the wireless terminal, and the message transmission and reception device includes: an accumulation monitoring unit that receives, from the relay device, the number of accumulated downstream messages accumulated in the relay device, to monitor a state of messages accumulated in the relay device; a flow instruction unit that instructs, on the basis of comparison of the accumulated message number received by the accumulation monitoring unit and a predetermined threshold, an amount of messages to be transmitted to the relay device by the message transmission and reception device; a flow control unit that controls, according to the instruction from the flow instruction unit, the amount of messages to be transmitted to the relay device; a transmission and reception information storage unit that stores information about messages transmitted from the message transmission and reception device to the relay device, and information about messages transmitted from the relay device to the message transmission and reception device; a priority control effect monitoring unit that calculates, when receiving a high priority message, the number of messages passed by the high priority message during a period from transmitting the high priority message from the relay device to receiving the high priority message on the basis of information of the transmission and reception information storage unit; and a threshold adjustment unit that adjusts the threshold on the basis of the passed message number calculated by the priority control effect monitoring unit.

### Effect of the Invention

According to a message transmission and reception device of the present invention, a threshold for determining the message amount transmitted to a relay device is adjusted on the basis of the number of messages that a high priority message transmitted from the relay device passes until the high priority message is received; therefore, the high priority message can be preferentially processed even in the multi-vendor environment.

### BRIEF DESCRIPTION OF THE DRAWINGS

FIG. 1 is a diagram that outlines a smart-meter automatic reading system;

FIG. 2 is a system configuration diagram that shows a message transmission and reception device according to an embodiment of the present invention;

FIG. 3 are tables that show contents of a transmission and reception information storage unit;

FIG. 4 are tables that show contents of a flow control information storage unit;

FIG. 5 is a flow chart that shows the operation of a flow control unit;

FIG. 6 is a flow chart that shows the operation of a flow instruction unit;

FIG. 7 is a flow chart that shows a passed-message counting operation in a priority control effect monitoring unit; and

FIG. 8 is a flow chart that shows the operation of a threshold adjustment unit.

### MODES FOR CARRYING OUT THE INVENTION

### Embodiment 1

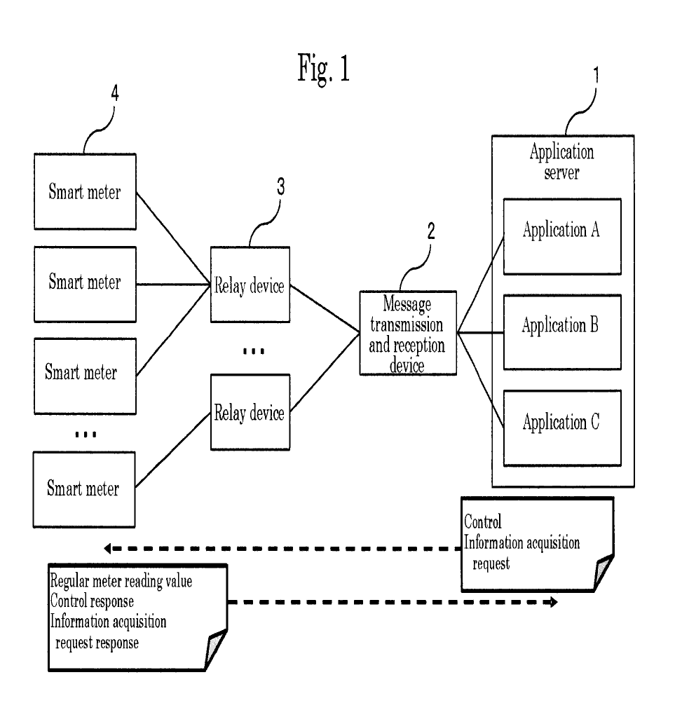

FIG. 1 is a diagram that outlines a smart-meter automatic reading system being an object of the present invention. In FIG. 1, the smart-meter automatic reading system has a tree structured network to connect smart meters 4, relay devices 3, a message transmission and reception device 2, and an application server 1; each smart meter 4 measures the usage amount of electricity, gas, water supply, or the like, and performs message communication with one or more applications operating on the application server through the message transmission and reception device 2 and the relay device placed between the message transmission and reception device 2 and the smart meters 4.

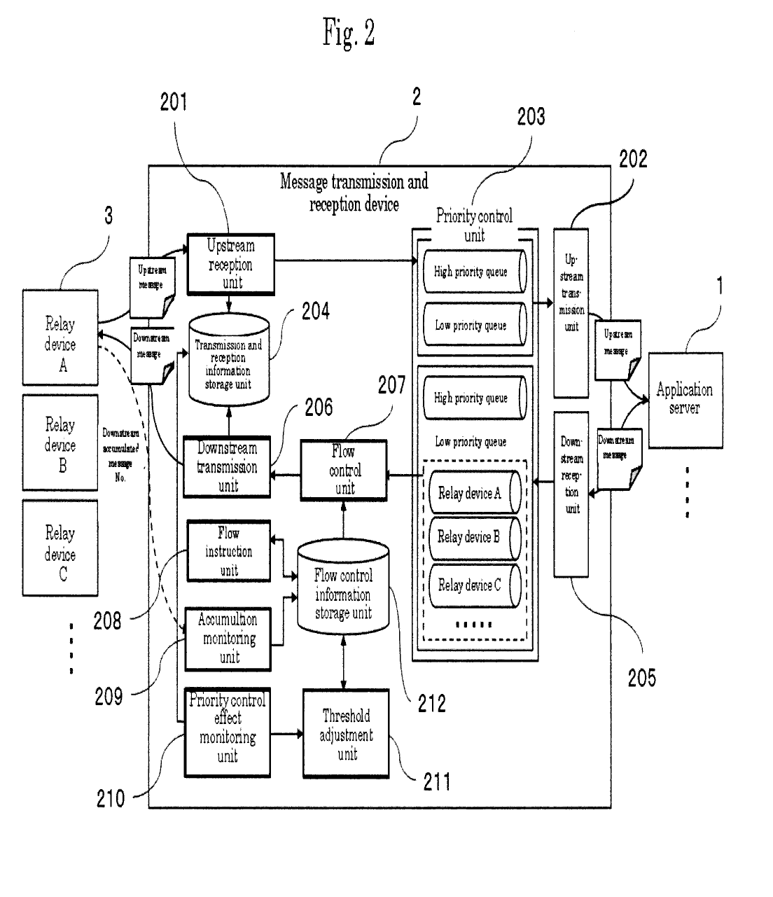

FIG. 2 is a system configuration diagram that shows the message transmission and reception device 2 according to an embodiment of the present invention. In the following, a message flowing in a direction from the relay devices 3 toward the application server 1 is called an upstream message, and a message flowing in a direction from the application server 1 toward the relay devices 3 is called a downstream message. In FIG. 2, the application server 1 is a device in which applications relating to automatic meter reading operate, and in which a plurality of applications uniquely identified by application IDs operates. The relay device 3 is a device that relays messages between the application server and the smart meters, and the message transmission and reception device 2 is a device that controls transmission and reception of messages between the applications operating on the application server 1 and the relay devices 3.

In the message transmission and reception device 2, an upstream reception unit 201 receives messages from the relay devices 3. An upstream transmission unit 202 transmits the messages to the application server 1. A priority control unit 203 performs priority control of upstream and downstream message communication. A transmission and reception information storage unit 204 stores communication records about upstream message reception and downstream message transmission. A downstream reception unit 205 receives messages from the application server 1. A downstream transmission unit 206 transmits the messages to the relay device 3. A flow control unit 207 controls flow amounts of messages transmitted to the relay devices 3. A flow instruction unit 208 instructs the flow amounts to be controlled by the flow control unit 207. An accumulation monitoring unit 209 monitors the numbers of downstream accumulated message in the relay devices 3. A priority control effect monitoring unit 210 monitors the effect of priority control on the basis of information stored in the transmission and reception information storage unit 204. A threshold adjustment unit 211 adjusts thresholds of the numbers of accumulated messages, which are criteria for the flow instruction unit 208 to determine the flow amounts of downstream messages. A flow control information storage unit 212 stores information necessary for flow control. The priority control unit 203 is provided with a high priority queue and a low priority queue as queues of respective priority levels for each of the upstream direction and the downstream direction. In addition, the downstream low priority queue includes a queue for each relay device connected to the message transmission and reception server 2.

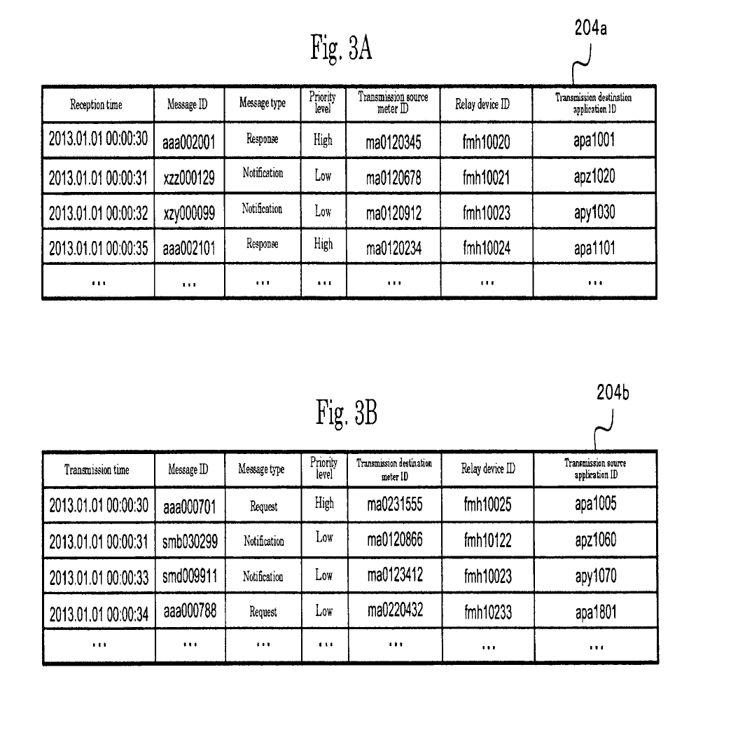

FIG. 3 are tables that show contents of the transmission and reception information storage unit 204. The transmission and reception information storage unit 204 includes a reception information table 204a shown in FIG. 3A and a transmission information table 204b shown in FIG. 3B. Items of the reception information table 204a include reception time, message ID, message type, priority level, transmission source meter ID, relay device ID, and transmission destination application ID; when the upstream reception unit 201 receives a message from a relay device 3, its items are additionally written in the reception information table. The reception time is a time when the upstream reception unit 201 receives a message. The message ID is an ID of the message to be uniquely identified, and is given by a transmission source application. With respect to a response message, the same message ID as that of a corresponding request message is given. As for the message type, “response” (a message in response to a request message) or “notification” (a spontaneous message from a smart meter) is given. The priority level is a priority level of a message to which a transmission source application gives “high”, or “low”. The transmission source meter ID is an ID by which to uniquely identify a meter having transmitted the message; the relay device ID is an ID by which to uniquely identify a relay device through which the message has passed. The transmission destination application ID is an ID to uniquely identify an application on the application server 1 to which the message is finally transmitted.

Items of the transmission information table 204b include transmission time, message ID, message type, priority level, transmission destination meter ID, relay device ID, and transmission source application ID; when the downstream transmission unit 206 transmits a message to a relay device 3, its items are additionally written in the transmission information table. The transmission time is a time when the downstream transmission unit 206 transmits a message. The message ID is an ID of the message to be uniquely identified, and is given by a transmission source application. As for the message type, “response” (a message in response to a request message) or “notification” (a unilateral message from a transmission source application) is given. The priority level is a priority level of a message to which a transmission source application gives “high”, or “low”. The transmission destination meter ID is an ID by which to uniquely identify a meter to which the message is finally transmitted; the relay device ID is an ID for uniquely identifying a relay device to which the downstream transmission unit transmits the message. The transmission source application ID is an ID to uniquely identify an application on the application server 1 which has transmitted the message.

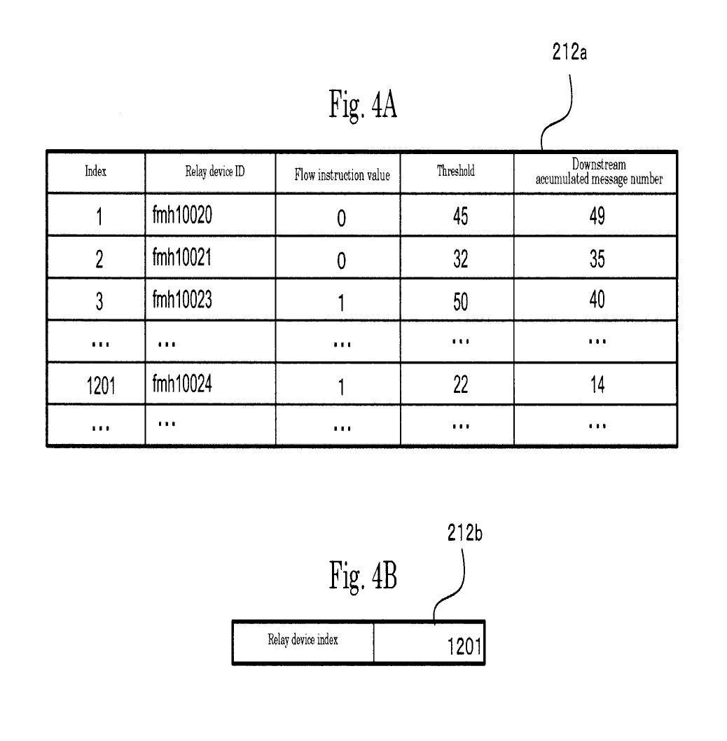

FIG. 4 are tables that show contents of the flow control information storage unit 212. The flow control information storage unit 212 includes a flow control information table 212a shown in FIG. 4A and a relay device index 212b shown in FIG. 4B. The flow control information table 212a stores indexes being sequential numbers in the table, relay device IDs each of which uniquely identifies a relay device connected to the message transmission and reception server 2, flow instruction values each of which indicates a content of a flow instruction from the flow instruction unit 208, thresholds each of which indicates a downstream accumulated message number to be a criterion for determining the flow instruction, and downstream accumulated message numbers each of which indicates a current accumulation state when determining the flow instruction. Here, in a case where a downstream accumulated message number is larger than the threshold, the flow instruction value becomes “0” to represent transmission suspension; in a case where the downstream accumulated message number is smaller than the threshold, the flow instruction value becomes “1” to represent transmission possible. The relay device index 212b is an index of the flow control information table 212a, indicating which relay device's low priority queue is to be next processed by the flow control unit 207.

(1) Operation when Receiving Upstream Message

When a relay device 3 transmits an upstream message to the message transmission and reception device 2, the upstream reception unit 201 stores the message's information such as the reception time, message type, message ID, priority level, transmission source meter ID, relay device ID, and transmission destination application ID in the transmission and reception information storage unit 204. In a case where the priority level of the received message is “high” and the message type thereof is “response”, the transmission and reception information storage unit 204 notifies the priority control effect monitoring unit 210 of the message ID of the received message. Furthermore, the upstream reception unit 201 transmits the message to the priority control unit 203. The priority control unit 203 places the received message into the high priority queue or the low priority queue according to its priority level. The upstream transmission unit 202 retrieves a massage from the high priority queue in a case where the high priority queue of the priority control unit contains messages, or retrieves a message from the low priority queue in a case where the high priority queue contains no messages; and then, the upstream transmission unit transmits the retrieved message to an application on the application server 1 indicated by the transmission destination application ID. The application on the application server 1 receives the transmitted message.

(2) Operation when Transmitting Downstream Message

When the application server 1 transmits a downstream message to the message transmission and reception server 2, the downstream reception unit 205 transmits the received message to the priority control unit 203. The priority control unit 203 places the message into a queue according to the message priority level and a relay device to which to transmit the message. In a case where the high priority queue of the priority control unit 203 contains messages, the flow control unit 207 retrieves a message from the high priority queue, to transmit the message to the downstream transmission unit 206; in a case where the high priority queue contains no messages, the flow control unit retrieves a message from a low priority queue according to flow control information in which commands of the flow instruction unit 208 are stored, to transmit the message to the downstream transmission unit. In the case where a message is retrieved from a low priority queue, the flow control unit 207 retrieves a message from the low priority queue for a relay device indicated by the relay device index 212b of the flow control information storage unit 212. On this occasion, if the flow instruction unit 208 commands that transmission to the relay device is suspended, the flow control unit operates so as not to retrieve a message from the low priority queue for the relay device but so as to retrieve a message from a low priority queue for the next relay device. The message sent from the flow control unit 207 to the downstream transmission unit 206 is transmitted to the relay device being the message transmission destination. After transmitting the message, the downstream transmission unit 206 stores as a transmission record, information such as transmission time, message type, message ID, priority level, transmission source application ID, transmission destination meter ID, and relay device ID in the transmission and reception information storage unit 204.

(3) Operation of Flow Control Unit 207

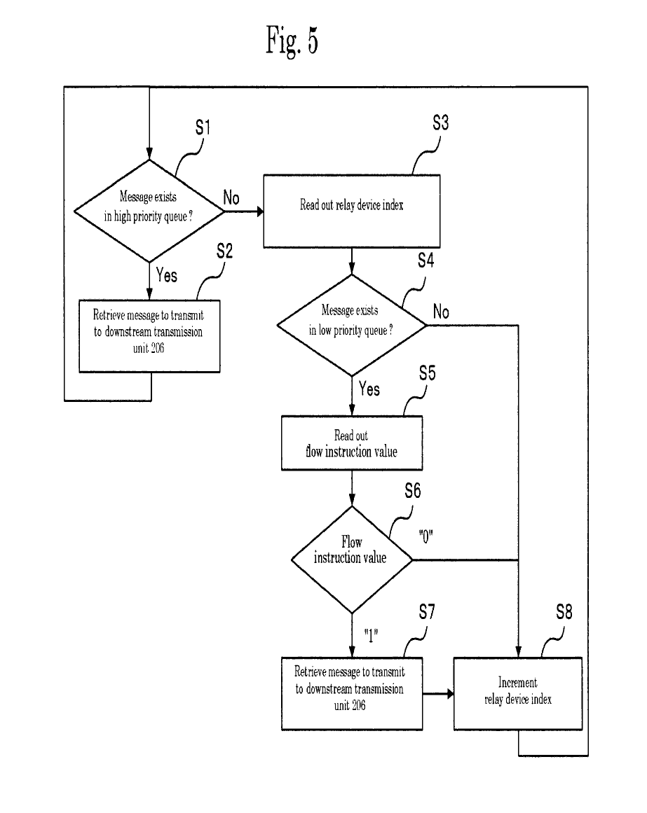

FIG. 5 is a flow chart that shows the operation of the flow control unit 207. The flow control unit 207 checks whether the high priority queue of the priority control unit 203 contains a message (S1); if containing a message, the flow control unit retrieves the message to transmit it to the downstream transmission unit 206 (S2), and then, the process returns to the beginning of the flow (S1). If the high priority queue contains no messages, the flow control unit reads out the relay device index 212b stored in the flow control information storage unit 212 (S3), to check whether a low priority queue for a relay device indicated by the relay device index 212b contains a message (S4); if containing a message, the flow control unit reads out from the flow control information storage unit 212, a flow instruction value for the corresponding relay device (S5). If the flow instruction value is “1(transmission possible)”, the flow control unit retrieves a message from the low priority queue, to transmit it to the downstream transmission unit 206 (S7) and increment the relay device index 212b (S8); then, the process returns to the beginning of the flow (S1). If the low priority queue contains no messages, or if the low priority queue contains a message but the relay device's flow instruction value read out from the flow control information storage unit 212 is “0 (transmission impossible)”, the flow control unit increments the relay device index 212b (S8); then, the process returns to the beginning of the flow (S1).

(4) Operation of Flow Instruction Unit 208

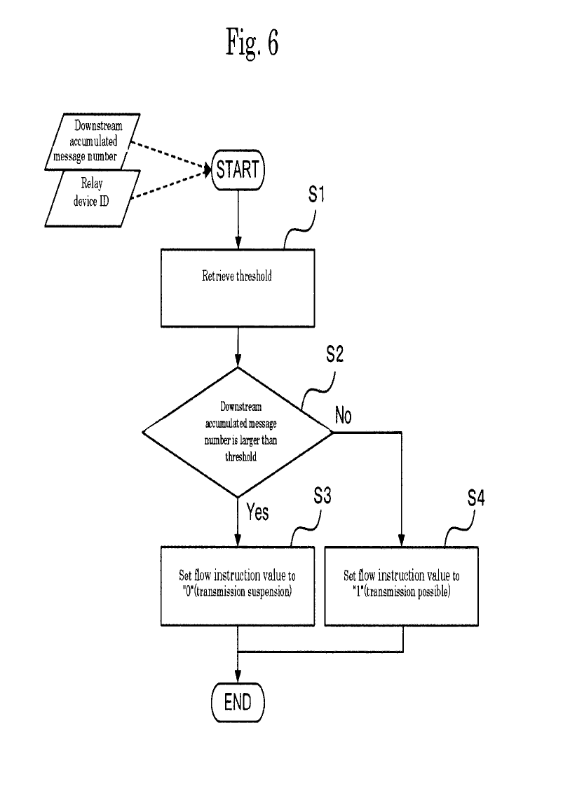

FIG. 6 is a flow chart that shows the operation of the flow instruction unit 208. The flow instruction unit 208 starts operation in response to notification of a downstream accumulated message number which has been written into the flow control information storage unit 212 by the accumulation monitoring unit 209 and a relay device ID.

First, the flow instruction unit 208 searches the flow control information storage unit 212 on the basis of the relay device ID, to retrieve a corresponding threshold (S1). Next, the flow instruction unit compares the retrieved threshold with the downstream accumulated message number reported from the accumulation monitoring unit 209 (S2). If the downstream accumulated message number is larger than the threshold, the flow instruction unit writes “0” (transmission suspension) into the flow instruction value for the relay device ID having been stored in the transmission and reception information storage unit 204 (S3); if the downstream accumulated message number does not exceed the threshold, the flow instruction unit writes “1” (transmission possible) into the flow instruction value for the relay device ID having been stored in the transmission and reception information storage unit 204 (S4).

(5) Operation of Accumulation Monitoring Unit 209

The accumulation monitoring unit 209 periodically receives from the relay device 3 the relay device's downstream accumulated message number, and overwrites the relay device's downstream accumulated message number stored in the flow control information storage unit 212 with the received downstream accumulated message number. The accumulation monitoring unit 209 notifies the flow control information storage unit 212 of the written downstream accumulated message number together with the relay device ID.

(6) Operation of Priority Control Effect Monitoring Unit 210

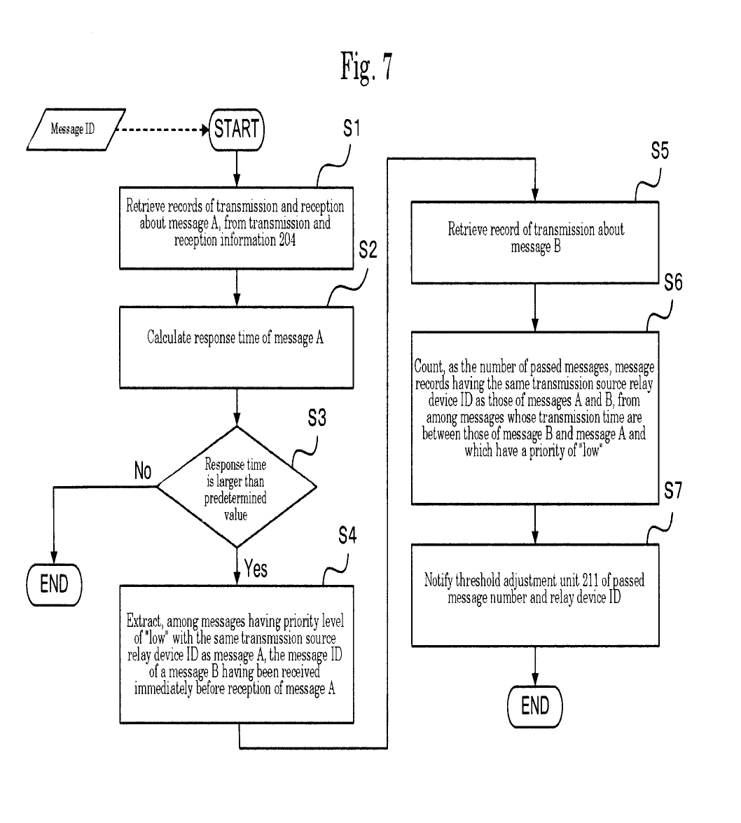

FIG. 7 is a flow chart that shows a passed-message counting operation in the priority control effect monitoring unit 210. When the upstream reception unit 201 receives a message (called as message A) whose priority level is “high” and whose message type is “response”, the priority control effect monitoring unit 210 is notified of the message ID of the message A, to start processing. The priority control effect monitoring unit 210 searches the transmission and reception information storage unit 204 on the basis of the message ID of the message A, to retrieve records when transmitting and receiving the message A (S1). Next, using time data in the retrieved records, the difference between the transmission time and the reception time is calculated as a response time of the message A (S2). The priority control effect monitoring unit compares the calculated response time with a predetermined value (S3); if the calculated response time is smaller than the predetermined value, the priority control effect monitoring unit determines that the priority control has effect, thereby ends the processing. If the calculated response time is larger than the predetermined value, the priority control effect monitoring unit determines that the priority control does not have effect, and counts, according to steps below, the number of messages that the message A passes in a period from the transmission of the message A to the reception of the message A, to thereby notify the threshold adjustment unit 211 of the counted message number together with the transmission source relay device ID (S4 to S7).

From the transmission and reception information storage unit 204, the priority control effect monitoring unit 210 extracts, among messages having a priority level of “low” and the same transmission source relay device ID as the message A, the message ID of a message (called as message B) having been received immediately before the reception of the message A (S4); and then, on the basis of the message ID of the message B, the priority control effect monitoring unit searches the transmission and reception information storage unit 204 to retrieve a record when sending the message B (S5). Furthermore, from among messages whose transmission time are between those of message B and message A and which have a priority of “low”, the priority control effect monitoring unit counts, as the number of passed messages, transmission records of messages having the same transmission source relay device ID as those of messages A and B (S6). The threshold adjustment unit 211 is notified of the counted passed message number together with the transmission relay device ID (S7).

(7) Operation of Threshold Adjustment Unit 211

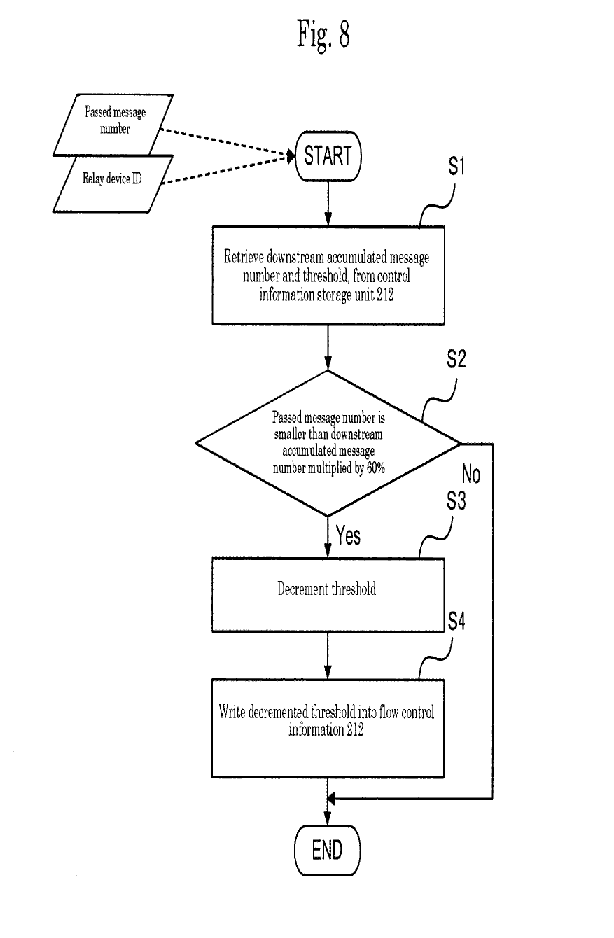

FIG. 8 is a flow chart that shows the operation of the threshold adjustment unit. When notified from the priority control effect monitoring unit 210 of the relay device ID and the passed messages number, the threshold adjustment unit 211 starts processing. On the basis of the relay device ID reported from the priority control effect monitoring unit 210, the threshold adjustment unit 211 searches the flow control information storage unit 212 to retrieve the downstream accumulated message number and the threshold corresponding to the relay device (S1). Next, the threshold adjustment unit compares the retrieved downstream accumulated message number with the passed message number reported from the priority control effect monitoring unit 210 (S2). If the passed message number is smaller than the downstream accumulated message number multiplied by a predetermined rate, the threshold adjustment unit decrements the threshold retrieved from the flow control information storage unit 212 (S3), to overwrite the threshold stored in the flow control information storage unit 212, with the decremented value (S4). The multiplication rate for the downstream accumulated message number is an adjustment value for reliably determining that the passed message number is sufficiently smaller than the downstream accumulated message number, to be set as a value such as 60%.

As described above, when the response performance for a high priority request message does not satisfy a performance set in advance, low priority messages are counted (the number of passed messages) which the high priority request message passes during a period from transmission of the high priority request message to reception thereof, so that if the counted value is sufficiently smaller than the downstream accumulated message number at the relay device, a threshold is adjusted which serves as a flow control criterion for stopping transmitting messages to the relay device. Therefore, in a multi-vendor environment, it is possible to set a suitable threshold for each relay device, regardless of whether priority control functions are included or implemented priority control methods are different in other companies' relay devices.

Furthermore, the message transmission amounts to the relay devices are controlled using thresholds suitable for the respective relay devices so that the number of downstream messages accumulated in each relay device is kept suitable. Therefore, even in a multi-vendor environment where the priority control method or the presence or absence of priority control function differs depending on each vendor, time for high priority request messages to wait in the relay devices are reduced, thereby making it possible to preferentially process high priority messages.

### INDUSTRIAL APPLICABILITY

The message transmission and reception device according to the present invention can be utilized for a message priority control method in transmitting and receiving meter reading data of smart meters and control data of the application server between wireless terminals and an application server.

### NUMERAL EXPLANATION

1 application server
2 message transmission and reception server
3 relay device

1. A message transmission and reception device that receives, through a relay device, an upstream message transmitted from a communication terminal to an application server, and that transmits, through the relay device to the communication terminal, a downstream message transmitted from the application server to the communication terminal, comprising:
an accumulation monitoring unit that receives, from the relay device, the number of accumulated downstream messages accumulated in the relay device, to monitor an accumulation state of messages in the relay device;
a flow instruction unit that instructs, on the basis of comparison of the accumulated message number received by the accumulation monitoring unit and a predetermined threshold, an amount of messages to be transmitted to the relay device by the message transmission and reception device;
a flow control unit that controls, according to the instruction from the flow instruction unit, the amount of messages to be transmitted to the relay device;
a transmission and reception information storage unit that stores information about messages transmitted from the message transmission and reception device to the relay device, and information about messages transmitted from the relay device to the message transmission and reception device;
a priority control effect monitoring unit that calculates, when receiving a high priority message from the relay device, the number of messages passed by the high priority message during a period from transmitting the high priority message to receiving the high priority message on the basis of information of the transmission and reception information storage unit; and
a threshold adjustment unit that adjusts the threshold on the basis of the passed message number calculated by the priority control effect monitoring unit.

2. The message transmission and reception device according to claim 1, wherein the priority control effect monitoring unit obtains, from the transmission and reception information storage unit, transmission time of the high priority message and transmission time of a low priority message that the message transmission and reception device receives immediately before the high priority message, and wherein the priority control effect monitoring unit calculates the passed message number by counting, during a period from the low priority message transmission time to the high priority message transmission time, messages transmitted from the message transmission and reception device to the relay device on the basis of information of the transmission and reception information retention storage unit.

3. An automatic meter reading system comprising the message transmission and reception device, the communication terminal provided with a smart meter, and the application server that are described in claim 1,
wherein meter reading data of the smart meter and control data of the application server are transmitted and received through the message transmission and reception device.

4. A message transmission and reception method by which an upstream message transmitted from a communication terminal to an application server is received through a relay device, and by which a downstream message transmitted from the application server to the communication terminal is transmitted through the relay device to the communication terminal, comprising:
obtaining information about priorities of the messages transmitted from the relay device;
calculating, when receiving a high priority message from the relay device, the number of messages passed by the high priority message during a period from transmitting the high priority message to receiving the high priority message;
adjusting, on the basis of the calculated passed message number, a threshold for determining the amount of messages to be transmitted to the relay device; and
receiving, from the relay device, the number of accumulated downstream messages accumulated in the relay device, to control the amount of messages to be transmitted to the relay device on the basis of a result of comparison of the received accumulated message number and the threshold.

5. The message transmission and reception method according to claim 5,
wherein transmission time of a low priority message received immediately before the high priority message and transmission time of the high priority message are obtained, and
wherein the passed message number is calculated by counting messages transmitted to the relay device during a period from transmission time of the low priority message to transmission time of the high priority message.

6. An automatic meter reading system comprising the message transmission and reception device, the communication terminal provided with a smart meter, and the application server that are described in claim 2,
wherein meter reading data of the smart meter and control data of the application server are transmitted and received through the message transmission and reception device.
